(19) United States
(12) Patent Application Publication
(10) Pub. No.: US 2021/0157271 A1
(43) Pub. Date: May 27, 2021

(54) 3D WALL CLOCK WITH INSTALLATION TEMPLATE

(71) Applicant: Curtis OKPARA, Sugar Land, TX (US)

(72) Inventor: Curtis OKPARA, Sugar Land, TX (US)

(21) Appl. No.: 16/690,569

(22) Filed: Nov. 21, 2019

(51) Int. Cl. G04B 19/06; G04B 19/12

(52) U.S. Cl. CPC G04B 19/06; G04B 19/12

(57) ABSTRACT

A 3D wall clock includes a template having at least four time indicator cutouts and a clock mechanism cutout, at least four time indicators, a clock mechanism, and hour and minute hands. Opposing time indicator cutouts are symmetrically aligned with each other. The template can be attached to a wall, the clock mechanism and time indicators can be positioned within a corresponding cutout and attached to the wall, and then, the template can be removed from the wall without disrupting the clock mechanism and time indicators. The template provides an aesthetically appealing, symmetrical, and customizable 3D wall clock.

### TECHNICAL FIELD

The field relates to 3D wall clocks. A template can be used to aid in easily spacing the clock components on a wall such that the components are evenly distributed.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a front view of a template for a 3D wall clock according to certain embodiments.

FIG. 2 is a back view of the template showing adhesive for securing the template to a wall.

FIG. 3 is a front view of time indicators according to certain embodiments.

FIG. 4 is a back view of a time indicator of FIG. 3 showing an adhesive for securing the time indicator to a wall.

FIG. 5 is a front view of the template showing the template folded for shipping according to certain embodiments.

FIG. 6 is front view of the template showing time indicators and a clock mechanism positioned within cutouts.

FIG. 7 is front view of the 3D wall clock after installation.

### DETAILED DESCRIPTION

3D wall clocks are becoming increasingly popular. A 3D wall clock is a clock without a case or housing and a face. Instead, the 3D wall clock includes two or more time indicators, a clock mechanism, and hour and minute hands that are removably attached directly onto a wall or other surface such as bricks of a fireplace. A customer or other person is then required to attach the 3D wall clock components onto the wall or other surface.

However, attaching the components of the 3D wall clock is not an easy task. Multiple measurements are required. By way of example, the perimeter of the time indicators must be measured depending on the diameter desired (e.g., 4 feet, 8 feet, 12 feet etc.). The person must try to accurately measure the desired diameter for each opposing set of time indicators, for example, the numbers 12 and 6, the numbers 3 and 9, and the numbers 2 and 8. By way of another example, the distance between each quartet of time indicators must be measured. A quartet of time indicators means all the time indicators falling between the primary time indicators. The primary time indicators are the numbers 12, 3, 6, and 9 as one moves in a clockwise direction from the 12 o'clock position. Accordingly, a first quartet of time indicators would be the numbers 1 and 2, which are between the numbers 12 and 3.

It is impossible or difficult at best to accurately measure and mark the positions of the 3D wall clock components. In reality, the time indicators may not appear to be evenly spaced for some or all of the quartet of time indicators due in part because some time indicators are single digits (e.g., 1, 2, 3, 6, and 9), while others are double digits (e.g., 10, 11, and 12). Accordingly, the last quartet of time indicators between the numbers 9 to 12 may not appear evenly spaced compared to the first quartet between the numbers 12 to 3. Additionally, the perimeter of the 3D wall clock as defined by the placement of the time indicators may not be consistent. Moreover, the line created between opposing time indicators may not be level, which creates a 3D wall clock that is askew. For example, the opposing time indicators 12 and 6 must be vertically level or plumb, while the opposing time indicators 3 and 9 must be horizontally level in order for the 3D wall clock to be aligned properly and look aesthetically appealing.

Even though some 3D wall clocks are sold with general instructions on how to measure and place the components of the clock, it is still very difficult to install the components such that the clock is aesthetically appealing. If the components are installed and errors are noticed, it is time consuming to dis-attach, re-measure, and re-attach the components. Also, some of the components of the 3D wall clock may have an adhesive on the back for attaching the components to the wall or other surface. In these instances, dis-attaching and re-attaching the components may not be possible.

Thus, there is a need for a way to accurately attach components of a 3D wall clock such that the clock is properly aligned, the components are perfectly spaced, and is aesthetically appealing.

It has been discovered that a 3D wall clock can include a template, time indicators, a clock mechanism, and hour and minute hands. The template includes pre-configured time indicator cutouts and a clock mechanism cutout. Installation onto a wall or other surface is simple, reliable, and perfectly arranged by attaching the time indicators and clock mechanism within the corresponding cutouts.

According to certain embodiments, a 3D wall clock comprises: a template, wherein the template comprises a first set of time indicator cutouts and a clock mechanism cutout, wherein the first set of cutouts comprises four cutouts corresponding to primary time indicators of 12 o'clock, 3 o'clock, 6 o'clock, and 9 o'clock; at least four time indicators; a clock mechanism; and an hour hand and a minute hand.

According to certain other embodiments, a method of installing a 3D wall clock comprises: removably attaching a template to a wall or other surface, wherein the template comprises time indicator cutouts and a clock mechanism cutout, wherein the time indicator cutouts comprise four cutouts corresponding to 12, 3, 6, and 9 o'clock positions of the clock; removably attaching at least four time indicators inside the time indicator cutouts ; removably attaching a clock mechanism inside the clock mechanism cutout; removing the template from the wall or other surface; and attaching an hour hand and minute hand to the clock mechanism.

It is to be understood that any discussion of any of the components disclosed herein is meant to include the apparatus and method embodiments without the need to repeat information. By way of example, any discussion related to the template or time indicators is meant to apply to the apparatus and method embodiments.

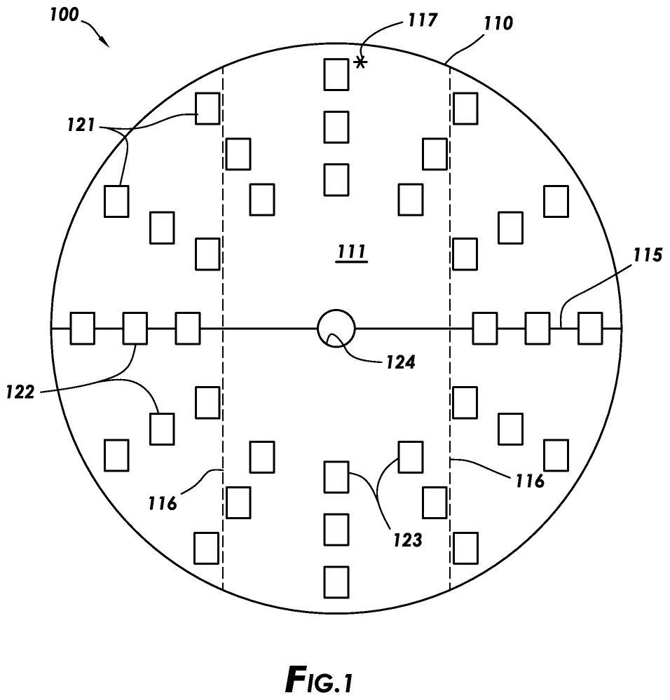

Turning to the figures, FIG. 1 shows a template 110 of the 3D wall clock 100. The template 110 can be made from a variety of materials. According to certain embodiments, the template 110 is made from a semi-rigid material. A semi-rigid material allows the template 110 to retain its shape, have increased durability, be tear resistant, and able to be folded for shipping. The template 110 can be made from flexible plastics, paper, or cardboard. If the template 110 is made from paper, then preferably the paper has a caliper measurement of at least 8 points, more preferably in the range of 8 points to 40 points. Caliper measurements can be used to determine the thickness of paper. A caliper is used to measure the thickness of the paper (sometimes referred to as stock or stock paper) in units of inches. The thickness in inches is then converted to points. One point equals 1/1,000 of an inch. If the paper is less than 8 points from a caliper measurement, then the paper can be coated with a flexible material, such as a wax, in order to increase the durability of the template 110. The flexible plastic and cardboard template can have a thickness in the range of, but not limited to, 1 millimeter (mm) to 5 mm.

The template 110 includes a first set of time indicator cutouts 121. The first set of time indicator cutouts 121 includes at least four cutouts corresponding to the primary time indicators of 12 o'clock, 3 o'clock, 6 o'clock, and 9 o'clock. The first set of time indicator cutouts 121 can be located near the periphery of the template 110. The distance between opposing primary time indicator cutouts (i.e., the 12 and 6 o'clock positions and the 3 and 9 o'clock positions) can vary and be selected based on the desired diameter of the 3D wall clock 100. By way of example, the distance between opposing primary time indicator cutouts can be in the range from, but not limited to, 12 inches to 5 feet. According to certain embodiments, the center point of the cutouts for the opposing primary time indicators are aligned with one another. By way of example, the center point for the 12 o'clock and 6 o'clock cutouts are vertically aligned or plumbed with each other, while the center point for the 3 o'clock and 9 o'clock cutouts are horizontally aligned with each other. In this manner, improved alignment and symmetry are achieved.

As shown in FIG. 1, the template 110 can further include time indicator cutouts for non-primary time indicators. The non-primary time indicators include the 1, 2, 4, 5, 7, 8, 10, and 11 o'clock positions. As discussed above with reference to the primary time indicator cutouts, the cutouts for opposing non-primary time indicators (e.g., the 2 o'clock and 8 o'clock positions) are a desired distance from each other based on the desired diameter of the 3D wall clock 100; and the center points of opposing cutouts are aligned with each other.

The 3D wall clock 100 also includes at least four time indicators 200. The at least four time indicators 200 correspond to the primary time indicators. Accordingly, a first time indicator would be placed within the 12 o'clock time indicator cutout, a second time indicator would be placed within the 3 o'clock time indicator cutout, etc. The 3D wall clock 100 can also include non-primary time indicators, which would equal a total of twelve time indicators. The template 110 can further include a 12 o'clock cutout time indicator 117. The 12 o'clock time indicator 117 can be used to show an installer which part of the template 110 is to be orientated at the top. Although the time indicators 200 shown in FIGS. 3, 4, 6, and 7 are Arabic numerals, the time indicators 200 can also be selected from the same or different geometric shapes (for example, bars, triangles, or squares), the same or different shapes (for example, fruit, trees, or animals), other numeral systems (for example, Roman, Indian, or Greek), or letters spelling the Arabic numeral (for example “three” for the number 3).

The time indicators 200 can be made from a variety of materials. According to certain embodiments, the time indicators 200 are made from a rigid material. The material can be selected from hard plastics, solid wood, compressed wood products, glass, epoxy materials, metals, or metal alloys. The time indicators 200 can be painted, stained, plated, and/or sealed with a sealant. Metal and metal alloys can include steel, stainless steel, polished nickel, brushed nickel, satin nickel, wrought iron, copper, brass, polished chrome, or bronze.

The dimensions of the time indicators 200 can vary. The height of the time indicators 200 at its largest measurement can be in the range of 1 inch to 12 inches. The width of the time indicators 200 at its largest measurement can be in the range of 0.75 inches to 8 inches. The dimensions of the time indicators 200 can be selected based on the desired diameter of the 3D wall clock 100. For example, as the diameter of the 3D wall clock 100 increases, the dimensions of the time indicators 200 can also increase. The dimensions of the first set of time indicator cutouts 121 are preferably selected such that the corresponding time indicator fits within the cutout with a clearance of 0.01 inches to 0.5 inches. By way of example, for Arabic or Roman numeral time indicators, the width for the cutout corresponding to the 12 o'clock position would be larger than the cutout corresponding to the 1 o'clock position because the Arabic numeral 12 has two digits (three digits for Roman numerals); whereas, the Arabic and Roman numeral 1 only has one digit. In this manner, the alignment and symmetry provided by the template is maintained. If the dimensions of the time indicator cutouts are much larger than the overall dimensions of the time indicators, then the proper alignment and spacing may not be achieved. According to certain other embodiments, for time indicators 200 containing 2 or more digits, the time indicator cutouts 121 can include two or more separate cutouts for each digit—for example, a first cutout for the number 1 and a second cutout for the number 2 to make the time indicator number 12. This embodiment can be useful for ensuring proper spacing distance between the two or more digits.

The template 110 also includes a clock mechanism cutout 124. The clock mechanism cutout 124 can be centrally located on the template 110. Preferably, the dimensions of the clock mechanism cutout 124 are selected such that a clock mechanism 300 fits within the cutout with a clearance of 0.01 inches to 0.5 inches. The clock mechanism cutout 124 can be circular, square, or rectangular in shape depending on the shape of the clock mechanism 300. The clock mechanism can also include a graphic on the front, such as sports logos, college names/logos, animals, cartoon characters, etc.

As shown in FIG. 1, the template 110 can further include a second set of time indicator cutouts 122 and further optionally includes a third set of time indicator cutouts 123. The discussion above regarding the dimensions, distance, and spacing of the first set of time indicator cutouts 121 equally applies to the second set of time indicator cutouts 122 and the third set of time indicator cutouts 123. The inclusion of at least the second set of time indicator cutouts 122 and optionally also the third set of time indicator cutouts 123 can be useful for providing two or three different 3D wall clock diameters in the same template 110. By way of example, the first set of time indicator cutouts 121 can have a diameter of 5 feet, the second set of time indicator cutouts 122 can have a diameter of 4.5 feet, and the third set of time indicator cutouts 123 can have a diameter 4 feet. The above example gives a diameter difference of 6 inches between the sets of time indicator cutouts; however, it is to be understood that the difference in diameter between the first set of time indicator cutouts 121 and the second set of time indicator cutouts 122 and the diameter between the second set of time indicator cutouts 122 and the third set of time indicator cutouts 123 can vary and can range from 1 inch to 2 feet.

As also shown in FIG. 1, the template 110 can further include a leveling line 115 that is etched or printed onto a front side 111 of the template 110. The leveling line 115 can be for example, a horizontal line that spans the entire diameter of the template 110 and runs through the center of each of the 9 o'clock time indicator cutout, the clock mechanism cutout 124, and the 3 o'clock time indicator cutout. In this manner, an installer can position a spirit level on the leveling line 115 to ensure the 3D wall clock 100 will be level and not be askew. A vertical leveling line or plumb line (not shown) can also be included instead of or in addition to the horizontal leveling line for ensuring the clock is plumb. The 3D wall clock 100 can further include one or more small levels approximately 2 inches long that can be removably attached to the front side 111 of the template 110 at the leveling line 115. The small level(s) can include an adhesive strip on the back for attaching to the front side 111 of the template 110. This embodiment can be useful to simplify attachment of the template 110 to a wall or other surface because the installer does not have to hold a spirit level in one hand while simultaneously rotating the template until the leveling line is level and attaching the template to the wall or other surface.

The template 110 can further include one or more folding lines 116. The folding lines 116 can be printed onto the front side 111 of the template 110 or can be scores for example for templates made from cardboard. The score lines preferably do not penetrate the entire thickness of the cardboard. FIG. 5 shows the sides of the template 110 folded along two folding lines 116, which reduces the overall size of the template 110 for ease in shipping. Although shown in FIGS. 1 and 5 with two folding lines 116 spanning vertically and located adjacent to both sides of the clock mechanism cutout 124, it is to be understood that only one or more than two folding lines 116 can be located in a variety of patterns on the template 110 to reduce the overall size of the template 110 for ease in shipping. According to certain embodiments, the folding lines 116 do not intersect any of the time indicator cutouts. This embodiment can be useful to ensure that the structural integrity and dimensions of the time indicator cutouts are maintained.

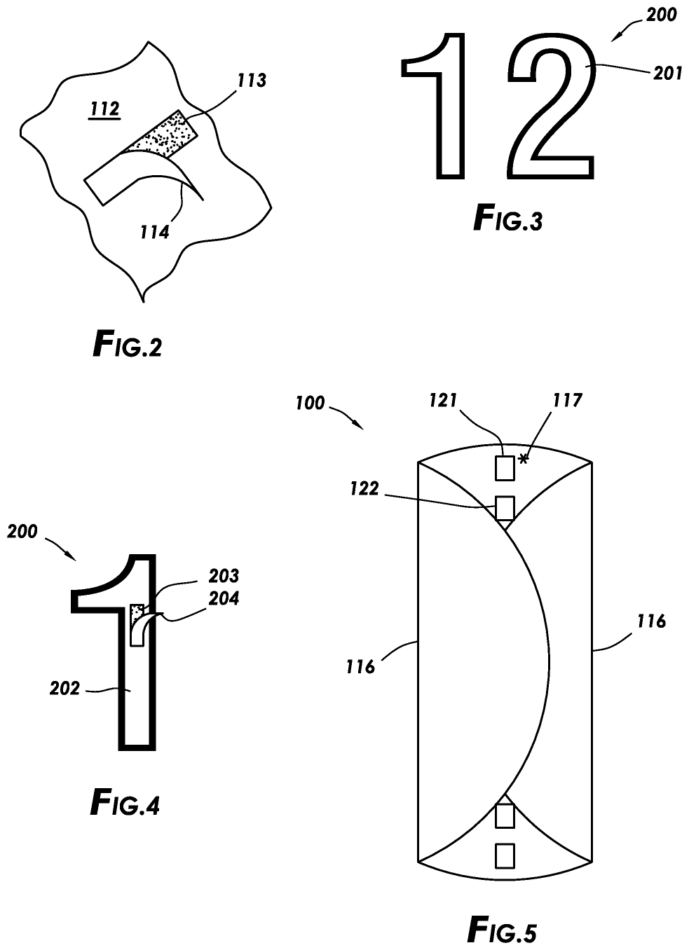

The methods include removably attaching the template 110 to a wall or other surface. According to certain embodiments, the template 110 is removably attached with an adhesive tape provided by the installer. The 3D wall clock 100 can also include a small roll of adhesive tape that an installer can use. According to certain other embodiments, and as shown in FIG. 2, a back side 112 of the template 110 includes a strip or plurality of strips of adhesive 113 (commonly referred to as double-sided tape). A single strip of adhesive 113 can be located around the entire perimeter of the back side 112 of the template 110. A plurality of strips of adhesive 113 can be positioned at various spacing distances from one another around the perimeter of the back side 112 of the template 110. The “perimeter” is the area within 2 inches from the edges of the template. The adhesive 113 has 2 sides, wherein a first side is pre-attached to the back side 112 of the template 110. The second side, which is the side opposite the first side, can include an adhesive covering 114. The adhesive covering 114 can prevent the second side of the adhesive 113 from sticking to objects prior to its intended use. The adhesive covering 114 can be, for example, a removable thin plastic or coated paper. In this manner, the adhesive covering 114 temporarily makes contact with the second side of the adhesive 113, but can be removed from the adhesive 113 by peeling the adhesive covering 114 off of the second side of the adhesive 113. The second side of the adhesive 113 is now available to adhere the template 110 to the wall or other surface by applying pressure from the front side 111 of the template 110 against the wall or other surface at the location(s) of the adhesive 113 strip(s). The adhesive 113 can be any type of adhesive that temporarily adheres the template 110 to the wall or other surface. A plurality of adhesive strips can alternatively be located on a front side 111 of the template 110 (commonly referred to as single-sided tape). According to this embodiment, a back side of a portion of each strip contains the adhesive and is adhered to the front side of the template at the edge of the template, with the remaining portion of each strip extending away from the edge of the template. The front side of each strip would not contain any adhesive. The portion of each strip that extends away from the edge of the template can include the adhesive covering 114. In this manner, an installer would simply remove the adhesive covering from the back side of each strip and attach the template to the wall or other surface by applying pressure to the front side of each strip.

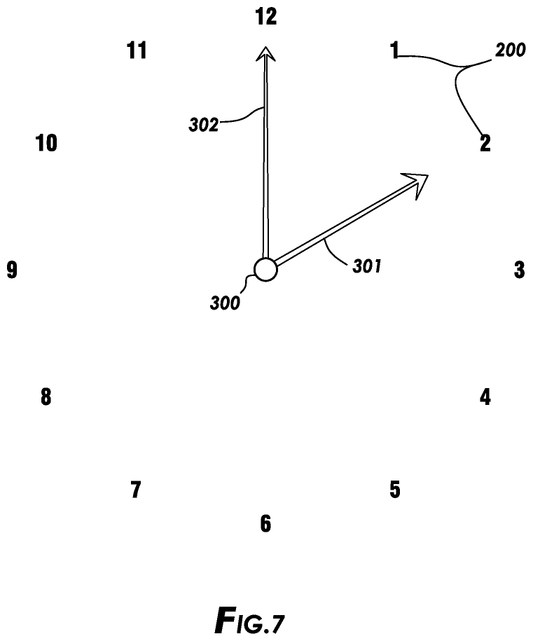

The methods also include removably attaching the four or more time indicators 200 inside the time indicator cutouts. If the template 110 includes a second set of time indicator cutouts 122 or optionally also the third set of time indicator cutouts 123, then the time indicators can be attached within the first, second, or third set of time indicator cutouts depending on the desired diameter of the 3D wall clock (e.g., 4 feet, 4.5 feet, or 5 feet in diameter). If the desired diameter of the 3D wall clock corresponds to the second set of time indicator cutouts 122, for example, then all of the time indicators 200 can be positioned within the second set of time indicator cutouts 122 with none being positioned within the first or third set of time indicator cutouts to create a circular wall clock. According to certain other embodiments, some of the time indicators 200 can be positioned within the first set of time indicator cutouts 121 and some of the other time indicators 200 can be positioned within the second and/or third set of time indicator cutouts 122 and/or 123 to give the clock a different look from the traditional circle. The hour and minute hands will still be able to tell time accurately because the time indicator cutouts are still within a linear plane. FIG. 6 shows one example of a template 110 having only a first set of time indicator cutouts 121 with twelve time indicators 200 (not just the four primary time indicators) being positioned within the first set of time indicator cutouts 121.

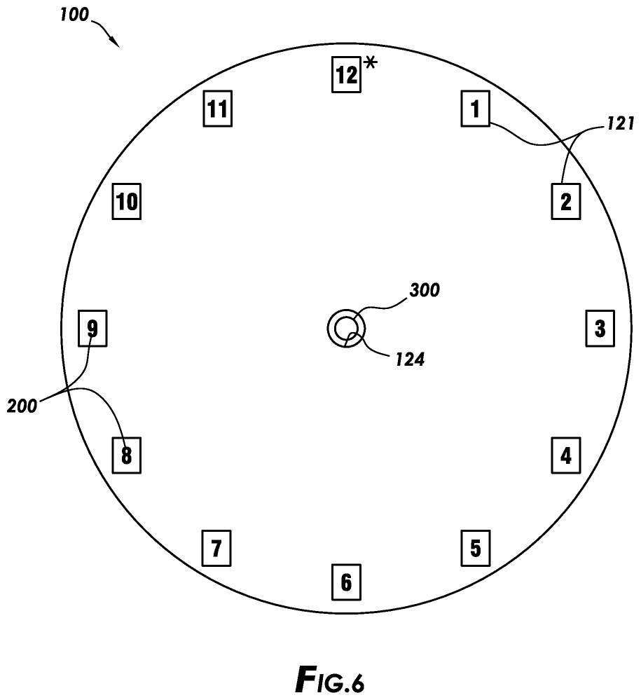

FIG. 4 shows a back side 202 of the time indicators 200 having an adhesive 203 strip and an adhesive covering 204. The adhesive 203 and adhesive covering 204 can be the same or different from the adhesive 113 and adhesive covering 114 for the template 110. For example, the adhesive 203 can be a stronger adhesive compared to the adhesive 113 for the template 110 because the additional adhesive strength may be needed to support the increased weight of the time indicators 200 compared to the template 110. However, it is to be understood that adhesive 203 and adhesive covering 204 should function the same as adhesive 113 and adhesive covering 114. The adhesive covering 204 can be removed and the time indicators 200 attached to the wall or other surface by applying pressure from the front side 201 of the time indicators 200 at the location of the adhesive 203 strip(s). Preferably, each time indicator includes at least one adhesive 203 strip, wherein the dimensions of the adhesive 203 strip is less than the dimensions of the back side 202 of the time indicator 200. In this manner, no adhesive 203 extends beyond the edges of the time indicator 200. According to certain embodiments, the number and location of the adhesive 203 strips are selected such that the time indicators 200 do not unintionally fall off the wall or other surface.

According to certain other embodiments, a nail or screw hole (not shown) is located near the top and back side 202 of each of the time indicators 200. The nail or screw hole can be used to receive the head of a nail or screw. The nails or screws can be inserted into the wall or other surface at the location of each nail or screw hole for removably attaching the time indicators 200 to the wall or other surface. The nail or screw hole will not penetrate the entire thickness of the time indicators 200.

The methods also include removably attaching the clock mechanism 300 inside the clock mechanism cutout 124, for example as shown in FIG. 6. The clock mechanism 300 can be any clock mechanism that keeps time and moves the hands of the clock. The clock mechanism 300 can include a power source, such as batteries, inserts for an hour hand 301 and minute hand 302, and any other components those of ordinary skill in the art will recognize are essential to a clock mechanism. The clock mechanism 300 can be a variety of shapes and sizes. The methods can further include inserting one or more batteries into a battery compartment of the clock mechanism prior to the step of removably attaching the clock mechanism to the wall or other surface. According to certain other embodiments, the battery compartment is located on a side of the clock mechanism 300 such that the battery compartment is accessible even if the clock mechanism 300 is attached to the wall or other surface. The battery compartment can be slid out from the clock mechanism housing to install or change the batteries. This embodiment can be useful for allowing the batteries to be replaced without having to remove the clock mechanism 300 from the wall or other surface.

The methods also include removing the template 110 from the wall or other surface. This step can be performed after the time indicators 200 and the clock mechanism 300 are removably attached to the wall or other surface. Because the time indicator cutouts and the clock mechanism cutout have a slightly larger perimeter than the time indicators and the clock mechanism, the template is able to be removed by pulling the template away from the wall or other surface at the location of the adhesive 113 strip(s). Accordingly, the template will move past the time indicators and the clock mechanism without disrupting the attachment of the time indicators and the clock mechanism. Preferably, the template 110 is gently pulled away from the wall or other surface such that the template 110 remains intact (i.e., is not torn or damaged) and the surface of the wall is not damaged. The template 110 can then be reused in another location if desired.

FIG. 7 shows the 3D wall clock 100 after the template 110 has been removed from the wall or other surface. The methods also include attaching the hour hand 301 and minute hand 302 to the clock mechanism 300 after removing the template 110. For templates that include second and optionally third sets of time indicator cutouts for providing multiple clock diameters, the hour and minute hands can include a telescopic portion for positioning the end of the hands a desired distance from the time indicators 200. By way of example, if the installer selects a 4 foot diameter, then the hands can be extended via the telescopic portion to be closer to the time indicators; whereas, if a 3 foot diameter is selected, then the hands can be shortened via the telescopic portion so the ends of the hands do not extend beyond the time indicators. The methods can further include positioning the hour hand 301 and minute hand 302 to the correct time after the step of attaching the hands to the clock mechanism.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more sets of cutouts, sides, ends, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a - b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A 3D wall clock comprising:
a template, wherein the template comprises a first set of time indicator cutouts and a clock mechanism cutout,
wherein the first set of cutouts comprises four cutouts corresponding to primary time indicators of 12 o'clock, 3 o'clock, 6 o'clock, and 9 o'clock;
at least four time indicators;
a clock mechanism; and
an hour hand and a minute hand.

2. The 3D wall clock according to claim 1, wherein the template is made from flexible plastics, paper, or cardboard.

3. The 3D wall clock according to claim 1, wherein a distance between opposing primary time indicator cutouts is in the range from 12 inches to 5 feet.

4. The 3D wall clock according to claim 1, wherein the template further comprises eight time indicator cutouts corresponding to non-primary time indicators.

5. The 3D wall clock according to claim 1, wherein the at least four time indicators are selected from numeral systems, geometric shapes, shapes, or letters.

6. The 3D wall clock according to claim 1, wherein the at least four time indicators are made from a material selected from hard plastics, solid wood, compressed wood products, glass, epoxy materials, metals, or metal alloys.

7. The 3D wall clock according to claim 1, wherein the dimensions of the first set of time indicator cutouts are selected such that a corresponding time indicator fits within the cutout with a clearance of 0.01 inches to 0.5 inches.

8. The 3D wall clock according to claim 1, wherein a time indicator cutout for receiving a time indicator having two or more digits consists of separate cutouts for each digit.

9. The 3D wall clock according to claim 1, wherein the first set of time indicator cutouts is located near the periphery of the template.

10. The 3D wall clock according to claim 1, wherein the height of the at least four time indicators at its largest measurement is in the range of 1 inch to 12 inches, and the width of the time indicators at its largest measurement is in the range of 0.75 inches to 8 inches.

11. The 3D wall clock according to claim 1, wherein the template further comprises a second set of time indicator cutouts or both a second set of time indicator cutouts and a third set of time indicator cutouts, wherein the second set and third set of time indicator cutouts have a different diameter from the first set of time indicator cutouts and each other.

12. The 3D wall clock according to claim 11, wherein a center point of opposing time indicator cutouts within the first set, second set, and third set of time indicator cutouts are aligned with one another.

13. The 3D wall clock according to claim 1, wherein the template further comprises a leveling line, wherein the leveling line is etched or printed onto a front side of the template.

14. The 3D wall clock according to claim 1, wherein the template further comprises one or more folding lines, wherein the one or more folding lines are etched, printed, or scored onto a front side of the template.

15. The 3D wall clock according to claim 1, wherein the template further comprises a strip or a plurality of strips of adhesive, wherein a first side of the strip or a plurality of strips of adhesive is adhered to a back side of the template, and wherein a second side of the strip or a plurality of strips of adhesive comprises an adhesive covering.

16. The 3D wall clock according to claim 1, wherein the template further comprises a plurality of adhesive strips located on a front side of the template, wherein a back side of a portion of each adhesive strip contains the adhesive and is adhered to the front side of the template at an edge of the template, wherein the remaining portion of each adhesive strip extends away from the edge of the template, wherein a front side of each adhesive strip does not contain any adhesive, and wherein the back side of the portion of each adhesive strip that extends away from the edge of the template comprises an adhesive covering.

17. The 3D wall clock according to claim 1, wherein the at least four time indicators comprise one or more strips of adhesive, wherein a first side of the one or more strips of adhesive is adhered to a back side of the at least four time indicators, and wherein a second side of the one or more strips of adhesive comprises an adhesive covering.

18. The 3D wall clock according to claim 1, wherein a nail or screw hole is located on a back side and near a top of the at least four time indicators.

19. A method of installing a 3D wall clock comprising:
removably attaching a template to a wall or other surface via an adhesive, wherein the template comprises time indicator cutouts and a clock mechanism cutout,
wherein the time indicator cutouts comprise four cutouts corresponding to 12, 3, 6, and 9 o'clock positions of the clock;
removably attaching at least four time indicators inside the time indicator cutouts;
removably attaching a clock mechanism inside the clock mechanism cutout;
removing the template from the wall or other surface; and
attaching an hour hand and minute hand to the clock mechanism.

20. The method according to claim 19, wherein the template is removed by pulling the template away from the wall or other surface at the location of the adhesive.
